(19) United States
(12) Patent Application Publication
(10) Pub. No.: US 2009/0122975 A1
(43) Pub. Date: May 14, 2009

(54) METHOD, SYSTEM AND APPARATUS FOR CONTROLLING AN ECHO CANCELLER DURING FAXING

(75) Inventor: Tong Jin, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/352,252

(22) Filed: Jan. 12, 2009

Related U.S. Application Data
(63) Continuation of application No. PCT/CN2007/070498, filed on Aug. 16, 2007.

(30) Foreign Application Priority Data
Aug. 18, 2006 (CN) 200610115877.0

(51) Int. Cl. H04M 9/08

(52) U.S. Cl. 379/406.01

(57) ABSTRACT

A method, an apparatus and a system for controlling an echo canceller in faxing are provided. The method includes: after detecting a triggering signal, the signal detecting apparatus enables the echo canceller to be in the initial state if the echo canceller is in the disabled state. In the apparatus and the system provided by embodiments of the present invention, a signal detecting apparatus is configured to detect the signals in the fax system. After a triggering signal is sent in the system, the disabled echo canceller is enabled to be in the initial state. In this way, the disabled echo canceller can be restarted during faxing. In the prior art, the disabled echo canceller is hard to be restarted during faxing. Hence, the technical solution provided by embodiments of the present invention may guarantee the fax reliability and the quality of the faxed images.

### CROSS-REFERENCE TO RELATED APPLICATIONS

This application is a continuation of International Application No. PCT/CN2007/070498, filed Aug. 16, 2007, which claims priority to Chinese Patent Application No. 200610115877.0, filed with the Chinese Patent Office on Aug. 18, 2006 and entitled “Method, System and Apparatis for Controlling an Echo Canceller During Faxing”, both of which are incorporated herein by reference in their entireties.

### FIELD OF THE INVENTION

The present invention relates to the field of communication technologies, and in particular, to a method, a system and an apparatus for controlling an echo canceller during faxing.

### BACKGROUND OF THE INVENTION

An echo is an acoustic wave or an electromagnetic wave that is reflected or indirectly propagated to a target point, with the amplitude and time delay that make the echo different from a direct wave. For example, when we make a call, especially a toll call, we sometimes hear our own voice after a time delay, which is echo. If the communication line is short and the delay is low, echo is hard to hear; if the line is long and the delay is high, the echo affects notably the communication quality.

As shown in FIG. 1, in a Public Switched Telephone Network (PSTN), the signal is generally transmitted through four wires: one wire is used for transmitting signals, one wire is used for receiving signals, and the remaining two ones are ground wires. The User Equipment (UE) uses two wires for transmission: one wire is used for transmitting and receiving signals, and the other is used as a ground wire. At the access point where the UE accesses the communication network, a 2/4-wire converter performs conversion between two-wire transmission and four-wire transmission. Ideally, the converter couples the remote signal to the 2-wire loop completely. In fact, because the impedance of the 2-wire loop device does not match with that of the 4-wire loop device, the converter couples only a large portion of signals to the 2-wire loop, and “leaks” a small portion of signals to the transmit path of the converter. The signals “leaked” onto the transmit path are echoes. In order to cancel or reduce echoes, an echo canceller is set at the 4-wire part of the network. The echo canceller estimates the size of the possible echoes on the receiving path according to the signals input remotely, and subtracts the estimated value of the echo from the locally input signals on the transmit path.

During faxing, echoes may be resolved as normal fax signals. This leads to failure of fax, reduces the Signal-to-Noise Ratio (SNR) of the faxed image and data, and affects the fax quality. Therefore, an echo canceller is configured in a communication network. Fax machines are categorized into ordinary fax machines and high-speed fax machines. A high-speed fax machine is a high-speed data terminal, which integrates the echo cancellation function to cancel the echoes during a high-speed data service.

When a high-speed fax machine sends a fax to another high-speed fax machine, the faxing abides by the high-speed fax process, and is a high-speed data service. With the echo cancellation function integrated in a high-speed fax machine, in order to prevent the secondary echo cancellation from affecting the fax reliability, the echo canceller configured in the network needs to be disabled (unless otherwise specified, the echo canceller mentioned hereinafter is an echo canceller configured in the network). Therefore, the International Telecommunications Union-Telecommunication Standardization Sector (ITU-T) G.168 protocol stipulates that after an echo canceller detects a signal of an amplitude-modulated answer tone with phase reversal (ANSam), the echo cancellation function is disabled. According to the protocol, the high-speed fax machine, when acting as a fax receiver, sends an ANSam signal to disable the echo canceller. Therefore, when an ordinary fax machine sends a fax to a high-speed fax machine, the high-speed fax machine disables the echo canceller. When an ordinary fax machine sends a fax to a high-speed fax machine, the faxing abides by the ordinary fax process, and is not a high-speed data service. Hence the echo cancellation function integrated in the high-speed fax machine is also disabled. Consequently, after the high-speed fax machine sends an ANSam signal to disable the echo canceller, the echo canceller is always disabled and unable to perform echo cancellation in the whole process of ordinary faxing, thus affecting the fax reliability and the image quality.

According to the ITU-T G.168 protocol, a disabled echo canceller can be enabled to be in the initial state only when the echo canceller detects that the bidirectional input signal levels are very low and lasts 400 ms. This protocol is intended for the scenarios where the fax service is followed by a voice call. For example, during faxing, if neither the sender nor the receiver hangs up, the fax machine returns to the voice state upon completion of the fax operation, and the sender and the receiver resumes to the conversation state. In this case, the echo canceller is required to continue working. In a normal conversation between two users, users do not always keep conversation, but tends to have an interval of more than half a second. During such an interval when neither party speaks, the bidirectional signal levels that enter the echo canceller are low, and the echo canceller can be enabled to be in the initial state again.

However, the ITU-T T.30 protocol does not stipulate that an interval of more than 400 ms must exist between the signals sent by the fax machines of both parties. Therefore, when an ordinary fax machine sends a fax to a high-speed fax machine, it is impossible to restart the echo canceller and enable the echo canceller to be in the initial state again in the ordinary fax process after the echo canceller is in the disabled state.

### SUMMARY OF THE INVENTION

Embodiments of the present invention provide a method, an apparatus and a system for controlling the echo canceller during faxing to enable the echo canceller to be in the initial state again, improving the fax reliability and ensuring the quality of the faxed images.

An embodiment of the present invention provides a method for controlling an echo canceller during faxing. The method includes:

after detecting a triggering signal, enabling the echo canceller to be in the initial state if the echo canceller is in the disabled state.

An embodiment of the present invention further provides a signal detecting apparatus in a fax system. The apparatus includes:

a signal input end, in communication with a sending fax machine, a receiving fax machine or the communication network, adapted to input triggering signals;

a detecting module, adapted to detect the triggering signals and the state of the echo canceller; and

a signal output end, in communication with the control signal input end of the echo canceller, adapted to output a control signal enabling or disabling an echo canceller; and wherein

if the detecting module detects a triggering signal and that the echo canceller is in the disabled state, the signal output end outputs the control signal enabling the disabled echo canceller to be in the initial state.

An embodiment of the present invention further provides an echo canceller in a fax system. The echo canceller includes a signal detecting module and an echo cancellation module. A signal input end of the signal detecting module, in communication with the sending fax machine, the receiving fax machine or the communication network, is adapted to input a triggering signal; and a signal output end of the signal detecting module, in communication with the control signal input end of the echo cancellation module, is adapted to output a control signal enabling a disabled echo cancellation module canceller to be in the initial state.

An embodiment of the present invention further provides an echo cancellation control apparatus in a fax system, and the echo cancellation control apparatus includes a signal detecting unit and an echo cancellation control unit; wherein:

the signal detecting unit is adapted to detect a triggering signal and the state of the echo canceller, and includes a signal input end in communication with the sending fax machine, the receiving fax machine or the communication network, and the signal input end is adapted to input the triggering signal; and

the echo cancellation control unit is adapted to output a control signal enabling the echo canceller to be in the initial state or disabling the echo canceller; and wherein

if the signal detecting unit detects the triggering signal and that the echo canceller is in the disabled state, the echo cancellation control unit enables the echo canceller to be in initial state.

Further; an embodiment of the present invention provides a fax system, which includes a sending fax machine, a receiving fax machine, an echo canceller, and a communication network, and the fax system further includes:

a signal detecting apparatus, adapted to detect a triggering signal and the state of the echo canceller; wherein

the sending fax machine and the receiving fax machine access the communication network through the echo canceller respectively, and the signal input end of the signal detecting apparatus is in communication with the sending fax machine, the receiving fax machine or the communication network, and is adapted to input a triggering signal; and

the signal output end of the signal detecting apparatus is in communication with the control signal input end of the echo canceller, and is adapted to output a control signal enabling a disabled echo canceller to be in the initial state.

In the technical solution provided by the embodiments of the present invention, a signal detecting apparatus is configured to detect the signals in the fax system. After a triggering signal is sent in the system, the disabled echo canceller is enabled to be in the initial state again. In this case, the disabled echo canceller may be restarted during faxing. In contrast, in the prior art, the disabled echo canceller is hard to restart during faxing. Hence, the technical solution provided by the embodiments of the present invention may guarantee the fax reliability and the quality of the faxed images.

In the prior art, when an ordinary fax machine sends a fax to a high-speed fax machine, after the echo canceller detects the ANSam signal sent by the high-speed fax machine, both parties enter an ordinary fax process, and the echo canceller is always disabled. If the technical solution under the present invention is applied, the echo canceller can be enabled to be in the initial state again after the signal detecting apparatus detects a triggering signal; afterward, the echo canceller is always in the enabled state, thus reducing the impact of echoes on the fax service and improving the fax reliability and the quality of the faxed images.

### BRIEF DESCRIPTION OF THE DRAWINGS

FIG. 1 is a block diagram showing a PSTN system in the prior art;

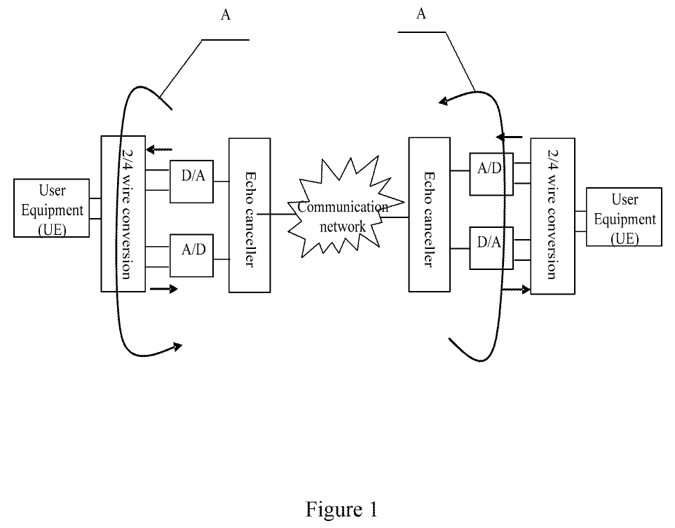

FIG. 2 is a block diagram showing a control system of an echo canceller during faxing according to a first embodiment of the present invention;

FIG. 3 is a flow chart showing a method for controlling an echo canceller during faxing according to the first embodiment of the present invention;

FIG. 4 is a block diagram showing a control system of an echo canceller during faxing according to a second embodiment of the present invention; and

FIG. 5 is a flow chart showing a method for controlling an echo canceller during faxing according to the second embodiment of the present invention.

### DETAILED DESCRIPTION OF THE EMBODIMENTS

For better understanding of the objectives, features and merits of the present invention, the present invention is hereinafter described in detail with reference to accompanying drawings and embodiments.

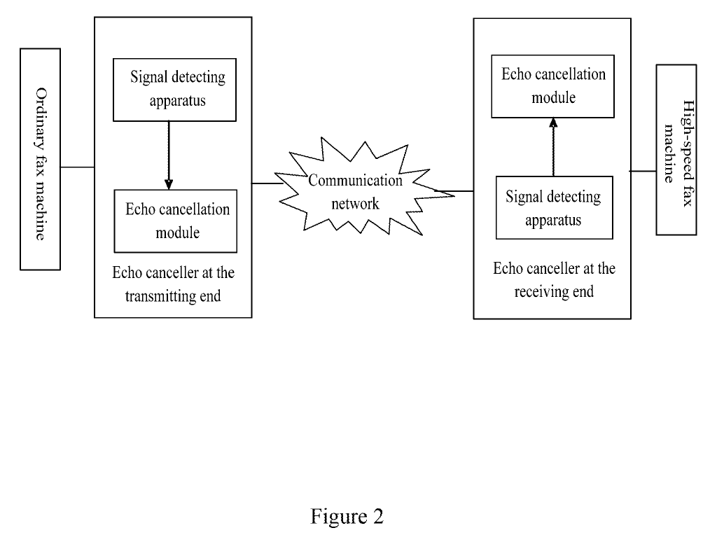

As shown in FIG. 2 to FIG. 5, an embodiment shows a method for controlling an echo canceller during faxing, and the method includes the following steps:

enabling the echo canceller to be in the initial state if the echo canceller is disabled after the signal detecting apparatus detects a triggering signal.

The triggering signal is a V.21 High-level Data Link Control (HDLC) preamble flag.

The V.21 HDLC preamble flag includes at least one of these items: the V.21 preamble flag signal, the event corresponding to the V.21 preamble flag signal, and the indication corresponding to the V.21 preamble flag signal. According to the ITU-T T.30 protocol, all V.21 messages in an ordinary taxing have a V.21 HDLC preamble flag signal as a prefix. This prefix is used by the fax machine to synchronize signals. A V.21 message includes a digital identification signal (DIS), a digital command signal (DCS), and etc. If the bearer network is an IP network, the event corresponding to the V.21 preamble flag signal is an event package of V.21 preamble flag signals defined in the IETF RFC2833 protocol. After detecting a V.21 preamble flag signal, the media processing apparatus at one end sends an event package of V.21 preamble flag signals to the media processing apparatus at the peer end through the IP bearer network. After receiving this event, the media processing apparatus at the peer end enables the echo canceller to be in the initial state.

The indications corresponding to the V.21 preamble flag signal include the indication message of V.21 preamble flag signals defined in the ITU-T H.248.2 protocol. After detecting a V.21 preamble flag signal, the media processing apparatus at one end notifies the media control apparatus that a V.21 preamble flag signal is detected. The media control apparatus sends an indication message of V.21 preamble flag signals to the media processing apparatus at the peer end. After receiving the message, the media processing apparatus at the peer end enables the echo canceller to be in the initial state.

The V.21 preamble flag signal is a continuous High-level Data Link Control (HDLC) frame synchronization byte, and adopts the modulation mode specified in the ITU-T V.21 protocol. The signal lasts 1±0.15 s. The V.21 HDLC preamble flag is hereinafter referred to as V.21 preamble flag.

The signal detecting apparatus may be deployed in an echo canceller, or in an echo canceller control apparatus, and the echo canceller control apparatus may be media gateway (MGW) or multimedia resource function processor (MRFP).

Before the detecting apparatus detects a triggering signal, the fax machines at both ends start the fax process.

In this embodiment, the sender is an ordinary fax machine and the receiver is a high-speed fax machine, the fax machines at both ends start the fax process and the method includes:

A. The ordinary fax machine acts as a fax sender, enters into the fax state, and sends a Calling Tone (CNG) signal to the fax machine of the receiver;

B. The high-speed fax machine acts as a fax receiver, enters into the fax state, and sends an ANSam signal to the fax machine of the sender;

C. After detecting the ANSam signal, the signal detecting apparatus disables the echo canceller according to the ITU-T G.168 protocol, and enters into the Tone Disable State;

D. The ordinary fax machine continues to send CNG signals to the high-speed fax machine;

E. If all ANSam signals are sent, the high-speed fax machine does not receive call menu (CM) signal from fax machine at the peer end in response to the ANSam signal, the high-speed fax machine sends a DIS signal to the fax machine at the peer end, and enter into the ordinary fax process.

Accordingly, a signal detecting apparatus in a fax system provided by an embodiment includes:

a signal input end, in communication with a sending fax machine, the receiving fax machine or the communication network, adapted to input triggering signals;

a detecting module, adapted to detect the triggering signals and the state of the echo canceller; and

a signal output end, in communication with the control signal input end of the echo canceller, adapted to output a control signal that enables the disabled echo canceller to be in the initial state.

If the detecting module detects a triggering signal and that the echo canceller is in the disabled state, the signal output end output the control signal that enables the disabled echo canceller to be in the initial state.

The input triggering signal is a V.21 preamble flag.

The V.21 preamble flag includes at least one of these items: the V.21 preamble flag signal, the event corresponding to the V.21 preamble flag signal, and the indication corresponding to the V.21 preamble flag signal.

The event corresponding to the V.21 preamble flag signal is an event package of V.21 preamble flag signals; the indication corresponding to the V.21 preamble flag signal is a V.21 preamble signal indication message.

The signal detecting apparatus may be deployed in an echo canceller.

Alternatively, the signal detecting apparatus may also be deployed in a control apparatus of an echo canceller.

A control apparatus of an echo canceller includes at least a media processing apparatus. The media processing apparatus includes at least an MGW or an MRFP.

The media processing apparatus is an MGW. The signal input end of the signal detecting apparatus in an MGW at one end inputs a V.21 preamble flag signal, and the signal output end outputs a control signal that enables a disabled echo canceller to be in the initial state; the signal output end is in communication with the signal input end of the signal detecting apparatus in the MGW at the peer end through an IP network, and is adapted to output an event package of V.21 preamble flag signals.

The media processing apparatus is an MRFP. The signal input end of the signal detecting apparatus in an MRFP at one end inputs a V.21 preamble flag signal, and the signal output end outputs a control signal that enables a disabled echo canceller to be in the initial state; the signal output end is in communication with the signal input end of the signal detecting apparatus in the MRFP at the peer end through a media control apparatus, and is adapted to output an indication message of V.21 preamble flag signals.

Further, an echo canceller in a fax system provided by an embodiment includes a signal detecting module and an echo cancellation module. A signal input end of the signal detecting module, in communication with the sending fax machine, the receiving fax machine or the communication network, is adapted to input a triggering signal; a signal output end of the signal detecting module, in communication with the control signal input end of the echo cancellation module, is adapted to output a control signal that enables a disabled echo cancellation module canceller to be in the initial state.

The triggering signal input by the signal input end of the signal detecting module is a V.21 preamble flag.

The V.21 preamble flag includes at least one of these items: the V.21 preamble flag signal, the event corresponding to the V.21 preamble flag signal, and the indication corresponding to the V.21 preamble flag signal.

The event corresponding to the V.21 preamble flag signal is an event package of V.21 preamble flag signals, and the indication corresponding to the V.21 preamble flag is a V.21 preamble signal indication message.

Further more, an echo canceller control apparatus in a fax system provided by an embodiment includes a signal detecting apparatus and an echo cancellation module. The signal detecting apparatus further includes:

a signal input end, in communication with the sending fax machine, the receiving fax machine or the communication network, adapted to input a triggering signal; and

a signal output end, in communication with the control signal input end of the echo canceller, adapted to output a control signal that enables a disabled echo canceller to be in the initial state.

The input triggering signal is a V.21 preamble flag.

The V.21 preamble flag includes at least one of these items: the V.21 preamble flag signal, the event corresponding to the V.21 preamble flag signal, and the indication corresponding to the V.21 preamble flag signal.

The event corresponding to the V.21 preamble flag signal is an event package of V.21 preamble flag signals, and the indication corresponding to V.21 preamble flag signal is a V.21 preamble signal indication message.

An echo canceller control apparatus includes at least a media processing apparatus. The media processing apparatus includes at least an MGW or an MRFP.

The media processing apparatus is an MGW. The signal input end of the signal detecting apparatus in the MGW at one end inputs a V.21 preamble flag signal, and the signal output end outputs a control signal that enables a disabled echo canceller to be in the initial state; the signal output end is in communication with the signal input end of the signal detecting apparatus in the MGW at the peer end through an IP network, and is adapted to output an event package of V.21 preamble flag signals.

The media processing apparatus is an MRFP. The signal input end of the signal detecting apparatus in the MRFP at one end inputs a V.21 preamble flag signal, and the signal output end outputs a control signal that enables a disabled echo canceller to be in the initial state; the signal output end is in communication with the signal input end of the signal detecting apparatus in the MRFP at the peer end through a media control apparatus, and is adapted to output an indication message of V.21 preamble flag signals.

Further, as shown in FIG. 2, a fax system provided by an embodiment includes a sending fax machine, a receiving fax machine, an echo canceller, a signal detecting apparatus and a communication network. The sending fax machine and the receiving fax machine access the communication network through the echo canceller respectively. The signal input end of the signal detecting apparatus is in communication with the sending fax machine, the receiving fax machine or the communication network, and is adapted to input a triggering signal. The signal output end of the signal detecting apparatus is in communication with the control signal input end of the echo canceller, and is adapted to output a control signal that enables a disabled echo canceller to be in the initial state.

In the fax system, the sending fax machine is an ordinary fax machine, and the receiving fax machine is a high-speed fax machine.

The triggering signal input by the signal input end of the signal detecting apparatus is a V.21 preamble flag.

The V.21 preamble flag includes at least one of these items: the V.21 preamble flag signal, the event corresponding to the V.21 preamble flag signal, and the indication corresponding to the V.21 preamble flag signal.

The event corresponding to the V.21 preamble flag signal is an event package of V.21 preamble flag signals, and the indication corresponding to the V.21 preamble flag signal is a V.21 preamble signal indication message.

The signal detecting apparatus is integrated with the echo canceller.

The signal detecting apparatus is in the echo canceller control apparatus.

The echo canceller control apparatus includes at least a media processing apparatus. The media processing apparatus includes at least one of these items: an MGW and an MRFP.

The media processing apparatus is an MGW. The signal input end of the signal detecting apparatus in an MGW at one end inputs a V.21 preamble flag signal, and the signal output end outputs a control signal that enables a disabled echo canceller to be in the initial state: the signal output end is in communication with the signal input end of the signal detecting apparatus in the MGW at the opposite end through an IP network, and is adapted output an event package of V.21 preamble flag signals.

The media processing apparatus is an MRFP. The signal input end of the signal detecting apparatus in an MRFP at one end inputs a V.21 preamble flag signal; the signal output end outputs a control signal that enables a disabled echo canceller to be in the initial state, and is in communication with the signal input end of the signal detecting apparatus in the MRFP at the peer end through a media control apparatus.

After the technical solution of the embodiments is applied, various fax processes are as follows:

I. The process of sending a fax from a high-speed fax machine to a high-speed fax machine is as follows.

1. A high-speed fax machine at the sending end enters into the fax state, and sends a CNG signal to the fax machine of the receiver.

2. A high-speed fax machine at the receiving end enters into the fax state, and sends an ANSam signal to the fax machine of the sender.

3. Upon receipt of an ANSam signal, the signal detecting apparatus disables the echo canceller.

4. Upon receipt of an ANSam signal, the high-speed fax machine of the sender sends a CM as a response, and enters into the high-speed fax process.

Because the signal detecting apparatus does not receive any V.21 preamble flag in the whole process of high-speed fax, the echo canceller is always in the disabled state.

II The process of sending a fax from a high-speed fax machine to an ordinary fax machine is as follows.

1. As a fax sender, the high-speed fax machine enters into the fax state, and sends a CNG signal to the receiving fax machine.

2. The ordinary fax machine enters into the fax state as a fax receiver, and sends a called terminal identifier (CED) signal to the fax machine of the sender.

3. After sending the CED signal, the ordinary fax machine sends a DIS signal and enters into the ordinary fax process.

Since the signal detecting apparatus detects no ANSam signal before entering the ordinary fax process, the echo canceller is always enabled throughout the process.

III. The process of sending a fax from an ordinary fax machine to an ordinary fax machine is as follows.

1. An ordinary fax machine at the sending end enters into the fax state as the fax sender, and sends a CNG signal to the fax machine of the receiver.

2. An ordinary fax machine at the receiving end enters into the fax state, and sends a CED signal to the fax machine of the sender.

3. After sending the CED signal, the ordinary fax machine at the receiving end sends a DIS signal to perform capability negotiation, and enters into the ordinary fax process.

Because the signal detecting apparatus detects no ANSam signal before entering the ordinary fax process, the echo canceller is always in the initial state throughout the process.

(IV) When an ordinary fax machine sends a fax to a high-speed fax machine, various embodiments are available. The following describes four embodiments.

### Embodiment 1

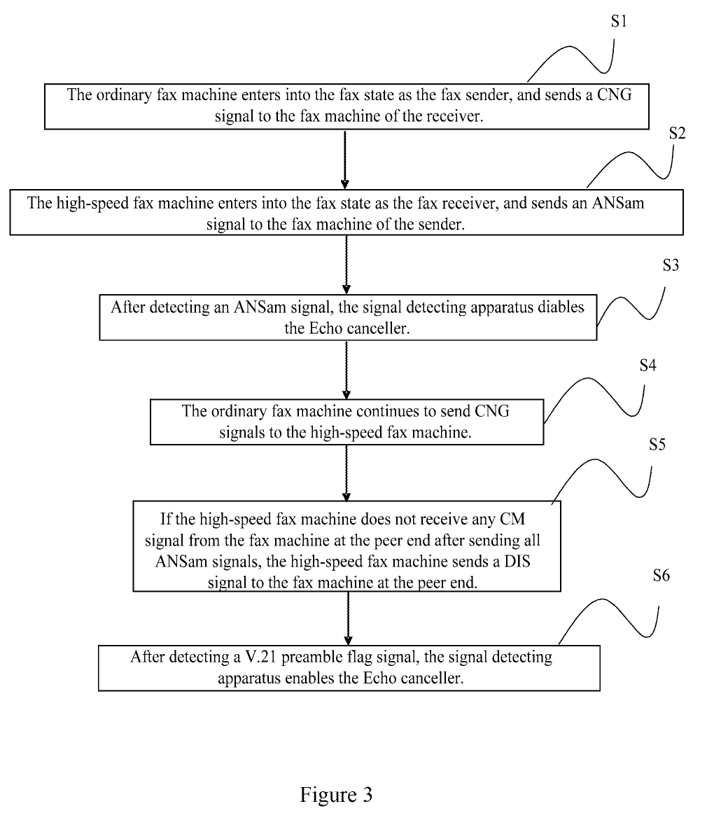

As shown in FIG. 2 and FIG. 3, in this embodiment, the signal detecting apparatus is deployed in the echo canceller. The embodiment provides a method for controlling the echo canceller during faxing and the method includes the following steps:

S1: The ordinary fax machine enters into the fax state as the fax sender, and sends a CNG signal to the fax machine of the receiver.

S2: The high-speed fax machine enters into the fax state as a fax receiver, and sends an ANSam signal to the fax machine of the sender.

S3: After detecting an ANSam signal, the signal detecting apparatus in the echo canceller in the communication line disables the echo canceller.

S4: The ordinary fax machine continues to send CNG signals to the high-speed fax machine.

S5: If the high-speed fax machine does not receives any CM signal from the fax machine at the peer end in response to the ANSam signal after sending all ANSam signals, the high-speed fax machine sends a DIS signal to the fax machine at the peer end to enter into the ordinary fax process.

S6: After detecting a V.21 preamble flag, the signal detecting apparatus in the echo canceller in the communication line enables the echo canceller to be in the initial state.

Embodiment 2

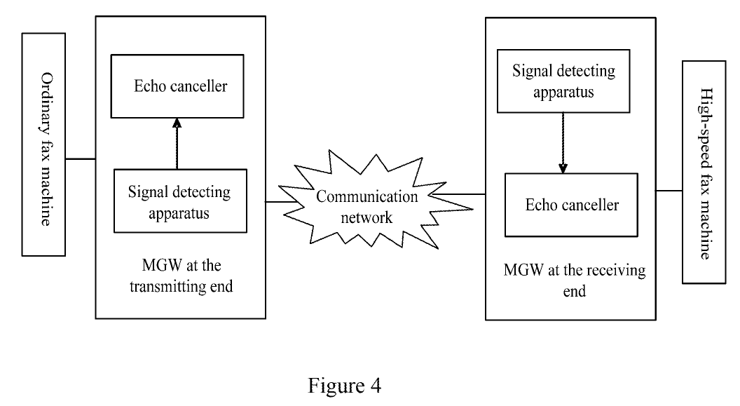

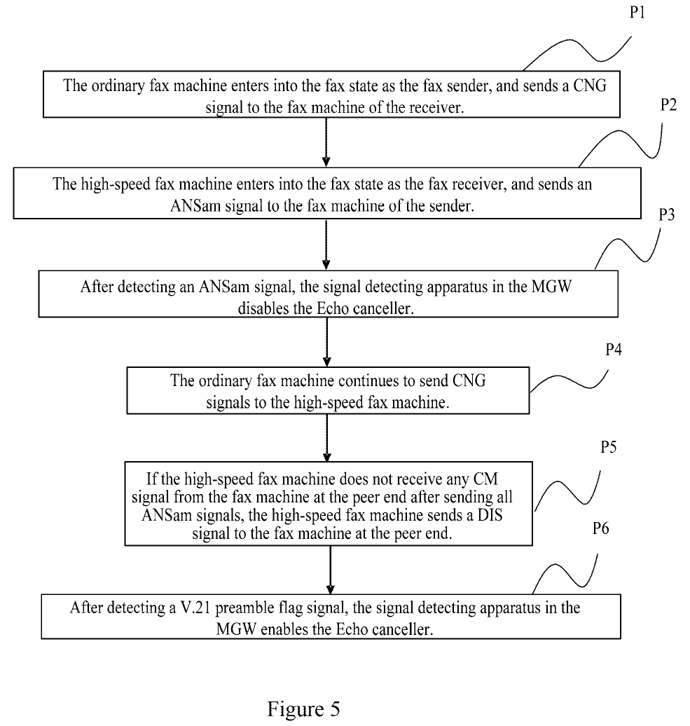

As shown in FIG. 4 and FIG. 5, in this embodiment, the signal detecting apparatus is deployed in an MGW with an echo canceller. This embodiment provides a method for controlling the echo canceller in faxing and the method includes the following steps:

P1: The ordinary fax machine enters into the fax state as a fax sender, and sends a CNG signal to the fax machine of the receiver.

P2: The high-speed fax machine enters into the fax state as a fax receiver, and sends an ANSam signal to the fax machine of the sender.

P3: After detecting an ANSam signal, the signal detecting apparatus or the echo cancellation module disables the echo canceller.

P4: The ordinary fax machine continues to send CNG signals to the high-speed fax machine.

P5: If the high-speed fax machine does not receive any CM signal from the fax machine at the peer end in response to the ANSam signal after sending all ANSam signals, the high-speed fax machine sends a DIS signal to the fax machine at the peer end to enter into the ordinary fax process.

P6: After detecting a V.21 preamble flag signal, the signal detecting apparatus in the MGW enables the echo canceller to be in the initial state.

This embodiment also provides an echo cancellation control apparatus in a fax system. The echo cancellation control apparatus includes a detecting unit and an echo cancellation control unit. The detecting unit includes a signal input end, in communication with the sending fax machine, the receiving fax machine or the communication network, and is adapted to input triggering signals.

The echo cancellation control unit is adapted to output a control signal that enables the echo canceller to be in the initial state or disables the echo canceller.

After the detecting unit detects a triggering signal, the echo cancellation control unit enables the echo canceller to be in the initial state if the echo canceller is in the disabled state.

The triggering signal is a V.21 preamble flag, and the detecting unit is able to detect the V.21 preamble flag.

### Embodiment 3

In this embodiment, the bearer network is an IP network, the event corresponding to the V.21 preamble flag signal is an event package of V.21 preamble flag signals, the media processing apparatus is an MGW, and the method for controlling the echo canceller in faxing includes the following steps:

1. The ordinary fax machine enters into the fax state as the fax sender, and sends a CNG signal to the fax machine of the receiver.

2. The high-speed fax machine enters into the fax state as the fax receiver, and sends an ANSam signal to the fax machine of the sender.

3. After detecting an ANSam signal, the signal detecting apparatus or the echo cancellation module disables the echo canceller.

4. The ordinary fax machine continues to send CNG signals to the high-speed fax machine.

5. If the high-speed fax machine does not receive any CM signal from the fax machine at the peer end in response to the ANSam signal after sending all ANSam signals, the high-speed fax machine sends a DIS signal to the fax machine at the peer end to enter into the ordinary fax process.

6. After detecting the V.21 preamble flag signal, the signal detecting apparatus in an MGW at one end starts the echo canceller at this end, and sends an event package of V.21 preamble flag signals to the MGW at the peer end through the IP network. After receiving the event package, the signal detecting apparatus in the MGW at the peer end enables the echo canceller to be in the initial state.

### Embodiment 4

In this embodiment, the indication corresponding to the V.21 preamble flag signal is an indication message of the V.21 preamble flag signals; the media processing apparatus is an MRFP; and the method for controlling the echo canceller in faxing includes the following steps:

1. The ordinary fax machine enters into the fax state as a fax sender, and sends a CNG signal to the fax machine of the receiver.

2. The high-speed fax machine enters into the fax state as a fax receiver, and sends an ANSam signal to the fax machine of the sender.

3. After detecting an ANSam signal, the signal detecting apparatus or the echo cancellation module built in the MRFP disables the echo canceller.

4. The ordinary fax machine continues to send CNG signals to the high-speed fax machine.

5. If the high-speed fax machine does not receive any CM signal from the fax machine at the peer end in response to the ANSam signal after sending all ANSam signals, the high-speed fax machine sends a DIS signal to the fax machine at the peer end to enter into the ordinary fax process.

6. After detecting the V.21 preamble flag signal, the signal detecting apparatus in the MRFP at one end starts the echo canceller at this end, and notifies the media control apparatus that a V.21 preamble flag signal is detected; the media control apparatus sends an indication message of V.21 preamble flag signals to the MRFP at the peer end; after detecting the indication message, the signal detecting apparatus of the MRFP at the peer end enables the echo canceller to be in the initial state.

According to the preceding embodiments, when an ordinary fax machine sends a fax to a high-speed fax machine, before entering the ordinary fax process, the echo canceller is disabled; after entering the ordinary fax process, the echo canceller is enabled again because the signal detecting apparatus detects that the V.21 preamble flag is used as the triggering signal.

The preceding embodiments of the present invention describe a method for controlling an echo canceller in faxing. Although the invention has been described through some exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for controlling an echo canceller during faxing, comprising:
after detecting a triggering signal, enabling the echo canceller to be in the initial state if the echo canceller is in the disabled state.

2. The method for controlling an echo canceller during faxing according to claim 1, wherein if a fax sender is an ordinary fax machine and a fax receiver is a high-speed fax machine, before detecting a triggering signal, the method further comprises:
disabling the echo canceller if detecting an ANSam signal sent by a fax receiver to a fax sender; and
after detecting the triggering signal sent by the fax receiver, enabling the echo to be in the initial state.

3. The method for controlling an echo canceller during faxing according to claim 2, wherein the triggering signal is a V.21 preamble flag.

4. The method for controlling an echo canceller during faxing according to claim 3, wherein
the V.21 preamble flag comprises at least one of these items: the V.21 preamble flag signal, the event corresponding to the V.21 preamble flag signal, and the indication corresponding to the V.21 preamble flag signal.

5. The method for controlling an echo canceller during faxing according to claim 4, wherein
the event corresponding to the V.21 preamble flag signal is an event package of V.21 preamble flag signals; and
the indication corresponding to the V.21 preamble flag signal is an indication message of V.21 preamble flag signals.

6. The method for controlling an echo canceller during faxing according to claim 4, wherein
the V.21 preamble flag signal is a continuous high-level data link control, HDLC, frame synchronization byte.

7. The method for controlling an echo canceller during faxing according to claim 1, wherein enabling the echo canceller to be in the enabled state comprises:
detecting the V.21 preamble flag signal;
starting the echo canceller at this end:
sending an event package of V.21 preamble flag signals to the peer end; and
enabling the echo canceller, by the peer end, after receiving the event package.

8. The method for controlling an echo canceller during faxing according to claim 1, wherein enabling the echo canceller to be in the initial state comprises:
detecting the V.21 preamble flag signal;
starting the echo canceller at this end;
notifying the media control apparatus that a V.21 preamble flag signal is detected,
sending an indication message of V.21 preamble flag signals to the peer end; and
enabling the echo canceller, by the peer end, after receiving the indication message.

9. A signal detecting apparatus in a fax system, comprising:
a signal input end, in communication with a sending fax machine, a receiving fax machine or the communication network, adapted to input triggering signals;
a detecting module, adapted to detect the triggering signals and the state of the echo canceller; and
a signal output end, in communication with the control signal input end of the echo canceller, adapted to output a control signal enabling or disabling echo canceller;
wherein the detecting module detects a triggering signal and that the echo canceller is in the disabled state, the signal output end outputs the control signal enabling the disabled echo canceller to be in the initial state.

10. The signal detecting apparatus according to claim 9, wherein
the input triggering signal is a V.21 preamble flag and the signal detecting apparatus is able to detect the V.21 preamble flag.

11. The signal detecting apparatus according to claim 9, wherein the signal detecting apparatus is deployed in the echo canceller or in an echo canceller control apparatus.

12. An echo canceller in a fax system, comprising a signal detecting module and an echo cancellation module, wherein
the signal input end of the signal detecting module, in communication with the sending fax machine, the receiving fax machine or the communication network, is adapted to input a triggering signal; and
the signal output end of the signal detecting module, in communication with the control signal input end of the echo cancellation module, is adapted to output a control signal enabling a disabled echo cancellation module canceller to be in the initial state.

13. The echo canceller according to claim 12, wherein
the triggering signal input by the signal input end of the signal detecting module is a V.21 preamble flag.

14. An echo cancellation control apparatus in a fax system, comprising a signal detecting unit and an echo cancellation control unit, wherein
the signal detecting unit is adapted to detect a triggering signal and the state of the echo canceller, and comprises a signal input end in communication with the sending fax machine, the receiving fax machine or the communication network, and the signal input end is adapted to input the triggering signal;
the echo cancellation control unit is adapted to output a control signal enabling the echo canceller to be in the initial state or disabling the echo canceller; and
the signal detecting unit detects the triggering signal, and the echo cancellation control unit enables the echo canceller to be in the initial state if the echo canceller is in the disabled state.

15. The echo cancellation control apparatus according to claim 14, wherein
the triggering signal is a V.21 preamble flag and the signal detecting unit is able to detect the V.21 preamble flag.

16. A fax system, comprising a sending fax machine, a receiving fax machine, an echo canceller, and a communication network, wherein the fax system further comprises:
a signal detecting apparatus, adapted to detect a triggering signal and the state of the echo canceller;
the sending fax machine and the receiving fax machine, which access the communication network through the echo canceller respectively;
the signal input end of the signal detecting apparatus, in communication with the sending fax machine, the receiving fax machine or the communication network, adapted to input a triggering signal; and
the signal output end of the signal detecting apparatus, in communication with the control signal input end of the echo canceller, adapted to output a control signal enabling a disabled echo canceller to be in the initial state.

17. The fax system according to claim 16, wherein
the sending fax machine is an ordinary fax machine; and
the receiving fax machine is a high-speed fax machine.

18. The fax system according to claim 16, wherein
the triggering signal input by the signal input end of the signal detecting apparatus is a V.21 preamble flag.

19. The fax system according to claim 18, wherein
the V.21 preamble flag comprises at least one of these items: the V.21 preamble flag signal, the event corresponding to the V.21 preamble flag signal, and the indication corresponding to the V.21 preamble flag signal.

20. The fax system according to claim 19, wherein
the event corresponding to the V.21 preamble flag signal is an event package of V.21 preamble flag signals; and
the indication corresponding to the V.21 preamble flag signal is a V.21 preamble signal indication message.

21. The fax system according to claim 16, wherein
the signal detecting apparatus is integrated with the echo canceller.

22. The fax system according to claim 20, wherein
the signal detecting apparatus is deployed in the echo canceller control apparatus.

23. The fax system according to claim 22, wherein
the echo canceller control apparatus comprises at least a media processing apparatus; and
the media processing apparatus comprises at least one of these items: a Media Gateway, MGW, and a Multimedia Resource Function Processor, MRFP.

24. The fax system according to claim 22, wherein
the media processing apparatus is an MGW;
the signal input end of the signal detecting apparatus in the MGW at one end inputs a V.21 preamble flag signal;
the signal output end outputs a control signal enabling a disabled echo canceller to be in the initial state;
the signal output end is in communication with the signal input end of the signal detecting apparatus in the MGW at the peer end through an IP network; and
the signal output end outputs an event package of V.21 preamble flag signals.

25. The fax system according to claim 22, wherein
the media processing apparatus is an MRFP;
the signal input end of the signal detecting apparatus in the MRFP at one end inputs a V.21 preamble flag signal;
the signal output end outputs a control signal enabling a disabled echo canceller to be in the initial state;
the signal output end is in communication with the signal input end of the signal detecting apparatus in the MRFP at the peer end through a media control apparatus.
